(19) United States
(12) Patent Application Publication
(10) Pub. No.: US 2026/0326473 A1
(43) Pub. Date: Oct. 22, 2026

(54) SECURITY ELEMENT

(71) Applicant: Hueck Folien Gesellschaft m.b.H., Baumgartenberg (AT)

(72) Inventors: Martin EGGINGER, Linz (AT); Anita FUCHSBAUER, Linz (AT); Stephan TRASSL, Baumgartenberg (AT); Philipp NOTHDURFT, Baumgartenberg (AT)

(21) Appl. No.: 18/994,587

(22) PCT Filed: Jul. 12, 2023
(86) PCT No.: PCT/AT2023/060233

§ 371 Date: Jan. 14, 2025

(30) Foreign Application Priority Data
Jul. 15, 2022 (EP) 22185201.5

(51) Int. Cl. B42D 25/324; B42D 25/328; B42D 25/373

(52) U.S. Cl. CPC B42D 25/324; B42D 25/328; B42D 25/373

(57) ABSTRACT

A security element, in particular for value papers, security papers or security articles, such as banknotes, identification cards, credit cards, has at least one region with structures, wherein at least one color-tilting optical effect layer is provided which produces a color-tilting effect when viewed from a first side of the security element in the at least one first region, and the structures are covered over the entire surface or partially by the at least one optical effect layer, wherein the structures are coated with at least one layer made of at least one metal, wherein the at least one layer made of the at least one metal is arranged between the structures and the optical effect layer as an adhesion promoter layer.

### RELATED APPLICATIONS

This is a national stage under 35 U.S.C. § 371 of International Application No. PCT/AT 2023/060233, filed Jul. 12, 2023, which claims priority of European Patent Application No. 22185201.5, filed Jul. 15, 2022.

### TECHNICAL FIELD

The field of the present disclosure relates to a security element, in particular for value papers, security papers or security articles, such as banknotes, identification cards or credit cards, wherein the security element has at least one region with structures, wherein at least one color-tilting optical effect layer is provided which causes a color-tilting effect in the at least one first region when viewed from a first face of the security element, and the structures are covered over the entire surface or partially by the at least one optical effect layer.

### BACKGROUND

Security elements that have structures with a large surface may cause problems with the adhesion of color-tilting optical effect layers to the structures. This may not only cause problems in production but may also affect the service life of the safety elements.

Thus, a need exists to improve the production and quality of a security element with structures and a color-tilting coating.

### SUMMARY

According to the present disclosure a security element of the type mentioned at the beginning in that the structures are coated with at least one layer made of at least one metal, the at least one layer made of the at least one metal being arranged between the structures and the optical effect layer as an adhesion promoter layer.

Embodiments according to the present disclosure enable a good adhesion between the structures and the color-tilting optical effect layer. The adhesion promoter layer also has an influence on the chemical resistance of the safety element.

According to an advantageous variant, it is provided that the structures are light-diffracting structures.

It has proven to be particularly advantageous that the structures have an aspect ratio of 0.05 to 3. It has been found that this variant, in combination with the metallic coating, enables the realization of a particularly good connection between light-diffracting structures and the color-tilting optical effect layer.

According to a preferred embodiment, it may be provided that the structures are embossed structures, in particular structures embossed in an embossing lacquer layer.

It may further be provided that a contour of the at least one layer made of metal follows a contour of the structures at least in portions, wherein in particular an interface of the at least one layer made of metal facing the optical effect layer follows the contour of the structures. This variant makes it possible for both the color tilting effect of the optical effect layer and an effect caused by the structures, such as a hologram, to be easily perceived at the same time.

Furthermore, it has proven to be particularly advantageous that the at least one layer made of metal covers at least those regions of the structures to which the at least one optical effect layer is applied. This variant makes it possible, on the one hand, to create translucent regions in a partial effect layer, which, for example, appear in the form of patterns, characters, images, etc., also known as “cleartext”, as well as to ensure good adhesion of the color-tilting effect layer to the structures.

It has proven to be particularly advantageous that the at least one metal of the at least one layer made of metal is selected from the group consisting of nickel, titanium, manganese, vanadium, chromium, cobalt, palladium, iron, tungsten, molybdenum, niobium, aluminum, silver, copper and/or alloys of these materials, in particular at least one nickel-chromium alloy, or is made from at least one of these materials. The metal layer serving as an adhesion promoter contains chromium and/or nickel. In particular, an alloy known as “Inconel” has proven to be especially suitable. Inconel is a nickel-chromium alloy whose main component is nickel and which contains chromium as the most important secondary component. In addition, iron, molybdenum, niobium, cobalt, manganese, copper, aluminum, titanium, silicon, carbon, sulfur, phosphorus and boron may be present. Such alloys are characterized by good adhesion promoting properties, especially to a metal layer of the color-tilting effect layer, and good corrosion resistance, especially to hydrochloric acid.

Advantageously, it may be provided that the optical effect layer is configured as a thin-film element and has at least one absorber layer and at least one spacer layer.

According to a preferred embodiment, it may be provided that the at least one absorber layer comprises at least one metallic material, in particular selected from the group consisting of nickel, titanium, vanadium, chromium, cobalt, palladium, iron, tungsten, molybdenum, niobium, aluminum, silver, copper and/or alloys of these materials, or is made of at least one of these materials.

Furthermore, it has proven to be advantageous that the at least one spacer layer is a low-refractive dielectric material with a refractive index of less than or equal to 1.65, in particular selected from the group consisting of aluminum oxide (Al₂O₃), metal fluorides, for example magnesium fluoride (MgF₂), aluminum fluoride (AlF₃), cerium fluoride (CeF₃), sodium aluminum fluorides (e.g. Na₃AIF₆ or Na₃Al₃F₁₄), silicon oxide (SiOₓ), silicon dioxide (SiO₂), neodymium fluoride (NdF₃), lanthanum fluoride (LaF₃), samarium fluoride (SmF₃), barium fluoride (BaF₂), calcium fluoride (CaF₂), lithium fluoride (LiF), low-refractive organic monomers and/or low-refractive organic polymers or at least one highly refractive dielectric material with a refractive index greater than 1.65, in particular selected from the group consisting of zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), Europium oxide (Eu₂O₃), iron oxides such as iron(II, III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SIC), silicon nitride (SisN₄), silicon monoxide (SiO), selenium trioxide (Se₂O₃), tin oxide (SnO₂), tungsten trioxide (WO₃), highly refractive organic monomers and/or highly refractive organic polymers or is made from at least one of these materials.

According to some embodiments, it may be provided that the optical effect layer configured as a thin-film element further comprises at least one reflective layer and/or a second absorber layer, wherein the at least one spacer layer is arranged between the at least one first absorber layer and the at least one reflective layer and/or the at least one second absorber layer.

According to a preferred embodiment, it is provided that the optical effect layer configured as a thin-film element further comprises at least one reflective layer and/or a second absorber layer, wherein the at least one spacer layer is arranged between the at least one first absorber layer and the at least one reflective layer and/or the at least one second absorber layer.

Furthermore, it has been found to be advantageous that the at least one reflective layer comprises at least one metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys or at least one highly refractive dielectric material with a refractive index of greater than 1,65, in particular selected from the group consisting of zinc sulphide (ZnS), zinc oxide (ZnO), titanium dioxide (TiO₂), carbon (C), indium oxide (In₂O₃), indium-tin oxide (ITO), tantalum pentoxide (Ta₂O₅), cerium oxide (CeO₂), yttrium oxide (Y₂O₃), europium oxide (Eu₂O₃), iron oxides such as iron(II, III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SIC), silicon nitride (Si₃N₄), silicon monoxide (SiO), selenium trioxide (Se₂O₃), tin oxide (SnO₂), tungsten trioxide (WO₃), highly refractive organic monomers and/or highly refractive organic polymers or is made from at least one of these materials.

It has proven to be particularly advantageous for the at least one reflective layer or at least one of the absorber layers to be applied directly to the metal layer serving as an adhesion promoter, in particular by printing and/or vapor deposition.

Further it may be provided that the security element comprises a base layer made of a plastic material wherein the plastic material is formed of a translucent and/or thermoplastic material, and that the base layer comprises preferably at least one material from the group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose-or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or at least one biologically degradable and/or marine-degradable plastic material and/or mixtures and/or co-polymers of these materials or is made from at least one of these materials.

It may further be advantageous that the security element is equipped with further color-tilting layers, in particular layers with color-tilting pigments or liquid crystals and/or with machine-readable features, the machine-readable features being in particular magnetic encodings, electrically conductive layers, electromagnetic wave-absorbing and/or re-emitting substances. In particular, it is conceivable for the security element to have additional layers, which additional layers include in particular protective coatings, heat-sealing lacquers, adhesives, primers and/or films.

### BRIEF DESCRIPTION OF THE DRAWING

For a better understanding of the invention, it is explained in more detail with the aid of the following figures.

These show in a very simplified schematic representation:

FIG. 1 a layered structure of a security element according to an embodiment.

### DETAILED DESCRIPTION OF EXEMPLARY EMBODIMENTS

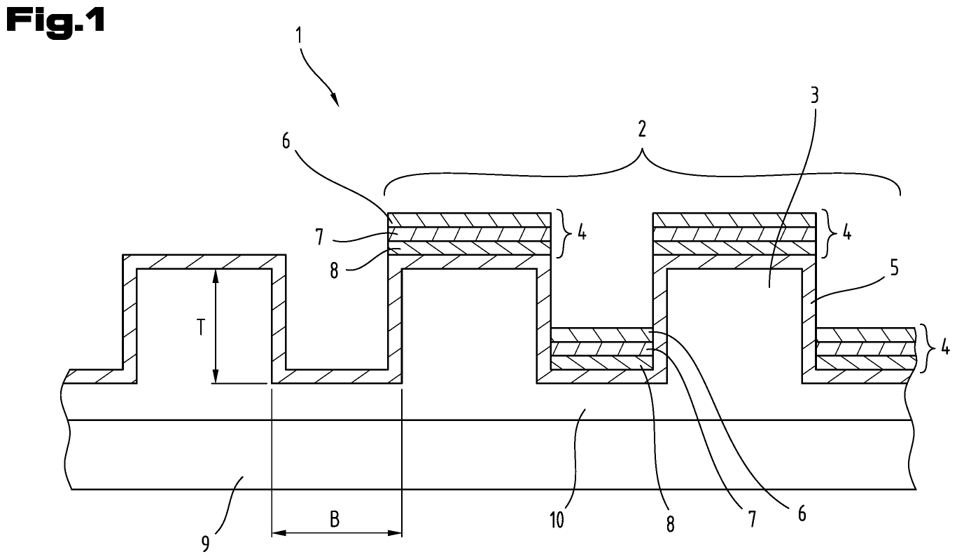

According to FIG. 1, a security element 1 according to an exemplary embodiment, as used for counterfeit protection of value papers, security papers or security articles, such as banknotes, identification cards, credit cards, tickets, etc., has a region 2 in which structures 3 are arranged. The region 2 may extend over a part of the safety element 1 or over the entire safety element 1. Structures 3 are configured in the region 2. The structures 3 are preferably light-diffracting or diffractive structures. The structures 3 may, for example, produce a hologram and have a favorable aspect ratio of 0.05 to 3. For structures with a right-angled angle of inclination, for example columnar structures, the aspect ratio is the ratio of depth T to width B of the structures 3. In the present context, the depth T of a structure 3 is understood to be a normal distance between the level of the lowest point and the level of the highest point of the structure 3. The width B of a structure 3 corresponds to the width of a depression in structure 3. For structures with an angle of inclination deviating from 90°, for example sawtooth-like structures, the aspect ratio represents the ratio of depth T to a peak-to-peak distance of the structures.

Preferably, the structures 3 have a depth T of greater than 100 nm, in particular between 100 to 2000 nm, especially 150 to 1500 nm.

The structures 3 are coated with a layer 5 of at least one metal or alloy. The layer 5 is arranged between the structures 3 and the optical effect layer 4 as an adhesion promoter layer.

The material of layer 5 is selected from the group consisting of nickel, titanium, manganese, vanadium, chromium, cobalt, palladium, iron, tungsten, molybdenum, niobium, aluminum, silver, copper and/or alloys of these materials, in particular at least one nickel-chromium alloy, or is made from at least one of these materials. The material of the layer 5 is in particular preferably chromium or a nickel-chromium alloy, such as Inconel.

A contour of the layer 5 preferably follows a contour of the structures 3, wherein in particular an interface of the layer 5 facing the optical effect layer 4 follows the contour of the structures 3. The at least one layer 5 made of metal covers at least those regions of the structures 3 to which the optical effect layer 4 is applied.

The optical effect layer 4 is preferably configured as a thin-film element. The optical effect layer 4, which is configured as a thin-film element, comprises at least one absorber layer 6 and at least one spacer layer 7.

The absorber layer 6 may comprise a metallic material, in particular selected from the group consisting of nickel, titanium, vanadium, chromium, cobalt, palladium, iron, tungsten, molybdenum, niobium, aluminum, silver, copper and/or alloys of these materials, or may be made of at least one of these materials.

The at least one spacer layer 7 may be formed of a dielectric material, for example. Furthermore, the at least one spacer layer 7 may be at least one low-refractive dielectric material with a refractive index of less than or equal to 1.65, in particular selected from the group consisting of aluminum oxide (Al₂O₃), metal fluorides, for example magnesium fluoride (MgF₂), aluminum fluoride (AlF₃), cerium fluoride (CeF₃), sodium aluminum fluorides (e.g. Na₃AlF₆ or Na₅Al₃F₁₄), silicon oxide (SiOₓ), silicon dioxide (SiO₂), neodymium fluoride (NdF₃), lanthanum fluoride (LaF₃), samarium fluoride (SmF₃), barium fluoride (BaF₂), calcium fluoride (CaF₂), lithium fluoride (LiF), low-refractive organic monomers and/or low-refractive organic polymers or at least one highly refractive dielectric material with a refractive index greater than 1.65, in particular selected from the group consisting of zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron(II, III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), highly refractive organic monomers and/or highly refractive organic polymers or be made from at least one of these materials.

The optical effect layer 4, which is configured as a thin-film element, is applied to the layer 5, which is arranged on the structures 3.

The thickness of the individual layers or plies forming the thin-film element is greatly exaggerated and shown out of scale.

The color-tilting optical effect layer 4 may also include a reflective layer 8. The at least one spacer layer 7 is arranged between the absorber layer 6 and the reflective layer 8. The reflective layer 8 is applied directly to the layer 5, which serves as an adhesion promoter layer, and may in particular be printed and/or vapor-deposited onto it. It is also conceivable to reverse this order in the optical effect layer so that the absorber layer is arranged on the layer 5, followed by the spacer layer and the reflective layer. The arrangement would therefore be according to the sequence of structures 3—metal layer 5—absorber layer 6—spacer layer 7—reflective layer 8. If the layer 5 and the absorber layer 6 consist of the same materials, it may be advantageous if they are applied in one step.

The reflective layer 8 may be a metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys or at least one highly refractive dielectric material with a refractive index of greater than 1.65, in particular selected from the group consisting of zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron(II, III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SIC), silicon nitride (Si₃N₄), silicon monoxide (SiO), selenium trioxide (Se₂O₃), tin oxide (SnO₂), tungsten trioxide (WO₃), highly refractive organic monomers and/or highly refractive organic polymers or be made from at least one of these materials. This applies to all reflective coatings 8 described in the exemplary embodiments.

Instead of the above-mentioned reflective layer 8, however, a further absorber layer may also be provided.

The security element 1 may further include a base layer 9. The base layer 9 may be formed of a plastic material. Furthermore, several layers may also form the base layer 8. The plastic may be formed of a translucent and/or thermoplastic material.

The base layer 9 may comprise at least one material from the group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF) and ethylene tetrafluoroethylene hexafluoropropylene fluorterpolymer (EFEP), and/or mixtures and/or co-polymers of these materials or be made from at least one of these materials. The base layer may have a thickness of 5 μm to 1000 μm, in particular preferably a thickness of 10 μm to 50 μm.

The arrangement or application of the optical effect layer 4 or its plies to the layer 5 may be carried out, for example, by a printing process and/or a vapor deposition process or several of these.

The structures 3 may be embossed directly into the base layer 9. For example, by heating the base layer 9 and embossing the structures using an embossing tool, such as an embossing roller.

Another alternative option is to provide a separate additional layer 10 to accommodate the structures 3. The additional layer 10 may be applied directly to the base layer 9. For example, the additional layer 10 may consist of an embossing lacquer, which is formed to match the arrangement of the structures 3. This may in turn be done using a molding device or a molding element in an embossing process. This additional layer, in particular an embossing lacquer layer, with the structures 3 formed therein may have a thickness of 0.5 μm to 300 μm, in particular 0.8 μm to 50 μm, preferably 1 μm to 10 μm.

Furthermore, at least one intermediate layer may be provided between the layer 10 and the base layer 9, which may be formed, for example, of an adhesion promoter, a primer, an adhesive or the like.

The top or outermost layer on the optical effect layer 4 may, for example, be a protective layer not shown here, which protects the entire layer and/or ply structure from mechanical damage such as scratches, grooves or the like. The protective layer could also be arranged on the side of the base layer facing away from the optical effect layer. A double-sided arrangement would also be conceivable. Preferably, the protective layer may also be used to achieve a flat surface for the safety element 1.

It should be mentioned that the layer structure and the arrangement of further layers depends on the way in which the security element is attached to a security object, as the side of the security element to be viewed after attachment is decisive. This means that the visible side can be viewed from above, as shown in the figures, but it is also possible to view the safety element from below, e.g. through a carrier.

At this point it should be noted that the phrase “a layer is applied to something” should be understood to mean that the layer may be applied directly, or that there may be one or more intermediate layers between the applied layer and what the layer is applied to. It should also be noted at this point that one or more intermediate layers may be arranged between the layers described in this document. It is therefore not absolutely necessary for the layers described to contact each other. It should also be noted that the term “layer” in this document is to be understood as meaning that a layer may also be made up of several sub-layers.

1. A security element for value papers, security papers or security articles, banknotes, identification cards or credit cards, comprising: at least one region with structures, wherein at least one color-tilting optical effect layer is provided which produces a color-tilting effect when viewed from a first face of the security element in the at least one first region, and the structures are covered over the entire surface or partially by the at least one color-tilting optical effect layer, wherein the structures are coated with at least one layer made of at least one metal, wherein the at least one layer made of the at least one metal is arranged between the structures and the optical effect layer as an adhesion promoter layer.

2. The security element according to claim 1, wherein the structures are light-diffracting structures.

3. The security element according to claim 1, wherein the structures have an aspect ratio of 0.05 to 3.

4. The security element according to claim 1, wherein the structures are embossed in an embossed lacquer layer.

5. The security element according to claim 1, wherein a contour of the at least one layer made of metal follows a contour of the structures at least in portions, or an interface of the at least one layer made of metal facing the optical effect layer follows the contour of the structures.

6. The security element according to claim 1, wherein the at least one layer made of metal covers at least those regions of the structures to which the at least one optical effect layer is applied.

7. The security element according to claim 1, wherein the at least one metal of the at least one layer made of metal is selected from the group consisting of nickel, titanium, manganese, vanadium, chromium, cobalt, palladium, iron, tungsten, molybdenum, niobium, aluminum, silver, copper, alloys of any of the foregoing, and combinations thereof.

8. The security element according to claim 1, wherein the optical effect layer is configured as a thin-film element and has at least one absorber layer and at least one spacer layer.

9. The security element according to claim 8, wherein, the at least one absorber layer comprises at least one metallic material, selected from the group consisting of nickel, titanium, vanadium, chromium, cobalt, palladium, iron, tungsten, molybdenum, niobium, aluminum, silver, copper copper, alloys of any of the foregoing, and combinations thereof.

10. The security element according to claim 8, wherein the at least one spacer layer is a low-refractive dielectric material with a refractive index of less than or equal to 1.65.

11. The security element according to claim 8, wherein the optical effect layer configured as a thin-film element further comprises at least one reflective layer and/or a second absorber layer, the at least one spacer layer being arranged between the at least one first absorber layer and the at least one reflective layer and/or the at least one second absorber layer.

12. The security element according to claim 11, wherein the at least one reflective layer comprises at least one metallic material, selected from the group consisting of silver, copper, aluminum, gold, platinum, niobium, tin, or nickel, titanium, vanadium, chromium, cobalt, palladium, and alloys of these materials, or at least one highly refractive dielectric material with a refractive index of greater than 1.65.

13. The security element according to claim 10, wherein the at least one reflective layer or at least one of the absorber layers is applied directly to the layer made of metal serving as an adhesion promoter, in particular is printed and/or vapor-deposited.

14. The security element according to further comprising a base layer made of a plastic material.

15. The security element according to claim 10, wherein the low-refractive dielectric material is selected from the group consisting of aluminum oxide (Al₂O₃), metal fluorides, magnesium fluoride (MgF₂), aluminum fluoride (AIF₃), cerium fluoride (CeF₃), sodium aluminum fluoride, silicon oxide (SiOₓ), silicon dioxide (SiO₂), neodymium fluoride (NdF₃), lanthanum fluoride (LaF₃), samarium fluoride (SmF₃), barium fluoride (BaF₂), calcium fluoride (CaF₂), lithium fluoride (LiF), low-refractive organic monomers, low-refractive organic polymers, and combinations thereof.

16. The security element according to claim 8, wherein the at least one spacer layer comprises at least one highly refractive dielectric material with a refractive index greater than 1.65.

17. The security element according to claim 16, wherein the highly refractive dielectric material is selected from the group consisting of zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides, iron(II, III) oxide (Fe₃O₄), iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), highly refractive organic monomers, highly refractive organic polymers, and combinations thereof.

18. The security element according to claim 12, wherein the at least one highly refractive dielectric material is selected from the group consisting of zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides, iron(II, III) oxide (Fe₃O₄), iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SIC), silicon nitride (Si₃N₄), silicon monoxide (SiO), selenium trioxide (Se₂O₃), tin oxide (SnO₂), tungsten trioxide (WO₃), highly refractive organic monomers, highly refractive organic polymers, and combinations thereof.

19. The security element according to claim 14, wherein the plastic material is formed of a translucent thermoplastic material.

20. The security element according to claim 14, wherein the plastic material is selected from the group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose-based plastics, lignin-based plastics, polyhydroxyalkanoates (PHA), thermoplastic starch (TPS), polylactic acid (PLA), polycaprolactone (PCL), polybutylene succinate (PBS), polybutylene adipate terephthalate (PBAT), biologically degradable plastic material, marine-degradable plastic material, mixtures of any such materials, co-polymers of any such materials, and combinations thereof.
